(19) United States
(12) Patent Application Publication
(10) Pub. No.: US 2015/0373210 A1
(43) Pub. Date: Dec. 24, 2015

(54) Device Management System That Improves Accuracy of Alert Notification, Device Management Apparatus, and Device Management Method

(71) Applicant: Kyocera Document Solutions Inc., Osaka (JP)

(72) Inventor: Michito Araki, Osaka (JP)

(21) Appl. No.: 14/747,897

(22) Filed: Jun. 23, 2015

(30) Foreign Application Priority Data
Jun. 23, 2014 (JP) 2014-128674

(51) Int. Cl. H04N 1/00

(52) U.S. Cl. CPC H04N 1/00074; H04N 1/00068

(57) ABSTRACT

A device management system includes an electronic device, a device management apparatus, a value acquiring circuit, a time calculation circuit, and an alert notification circuit. The alert notification circuit notifies an alert indicating that an adjustment-limit time calculated by the time calculation circuit is close. The time calculation circuit calculates a predicted value of the use amount value where the adjusting value reaches the limit based on a log of combinations of the use amount values and the adjusting values, the use amount value and the adjusting value being acquired by the value acquiring circuit, and the time calculation circuit calculates the time at which the use amount value reaches the calculated predicted value based on a log of the use amount values as the adjustment-limit time.

### INCORPORATION BY REFERENCE

This application is based upon, and claims the benefit of priority from, corresponding Japanese Patent Application No. 2014-128674 filed in the Japan Patent Office on Jun. 23, 2014, the entire contents of which are incorporated herein by reference.

### BACKGROUND

Unless otherwise indicated herein, the description in this section is not prior art to the claims in this application and is not admitted to be prior art by inclusion in this section.

As a typical device management method, a method that calculates a time at which a used amount of a component of an electronic device reaches a predetermined upper limit and informs an alert that the calculated time is close has been known.

### SUMMARY

A device management system according to an aspect of the disclosure includes an electronic device, a device management apparatus, a value acquiring circuit, a time calculation circuit, and an alert notification circuit. The electronic device outputs a use amount value and an adjusting value. The use amount value indicates a use amount of the electronic device and an adjusting value necessary to be adjusted corresponding to the use amount of the electronic device. The device management apparatus controls the electronic device. The value acquiring circuit acquires the use amount value and the adjusting value from the electronic device. The time calculation circuit calculates an adjustment-limit time at which the adjusting value of the electronic device reaches a limit of an adjustment of the electronic device. The alert notification circuit notifies an alert indicating that the adjustment-limit time calculated by the time calculation circuit is close. The time calculation circuit calculates a predicted value of the use amount value where the adjusting value reaches the limit based on a log of combinations of the use amount values and the adjusting values, the use amount value and the adjusting value being acquired by the value acquiring circuit, and the time calculation circuit calculates the time at which the use amount value reaches the calculated predicted value based on a log of the use amount values as the adjustment-limit time.

These as well as other aspects, advantages, and alternatives will become apparent to those of ordinary skill in the art by reading the following detailed description with reference where appropriate to the accompanying drawings. Further, it should be understood that the description provided in this summary section and elsewhere in this document is intended to illustrate the claimed subject matter by way of example and not by way of limitation.

### BRIEF DESCRIPTION OF THE DRAWINGS

FIG. 1 illustrates a device management system according to an embodiment of the disclosure.

FIG. 2 illustrates an MFP according to the embodiment.

FIG. 3 illustrates a cloud server according to the embodiment.

FIG. 4 illustrates an exemplary voltage value database according to the embodiment.

FIG. 5 illustrates an exemplary counter value database according to the embodiment.

FIG. 6 illustrates a performance of the cloud server according to the embodiment when calculating an adjustment-limit time.

FIG. 7 illustrates an exemplary scatter diagram of combinations of counter values and drum voltage values of a plurality of MFP in the voltage value database according to the embodiment.

FIG. 8 illustrates an exemplary scatter diagram of the counter values in the counter value database according to the embodiment.

### DETAILED DESCRIPTION

Example apparatuses are described herein. Other example embodiments or features may further be utilized, and other changes may be made, without departing from the spirit or scope of the subject matter presented herein. In the following detailed description, reference is made to the accompanying drawings, which form a part thereof.

The example embodiments described herein are not meant to be limiting. It will be readily understood that the aspects of the present disclosure, as generally described herein, and illustrated in the drawings, can be arranged, substituted, combined, separated, and designed in a wide variety of different configurations, all of which are explicitly contemplated herein.

The following describes an embodiment of the disclosure with reference to the drawings.

First, a configuration of a device management system according to the embodiment will be described.

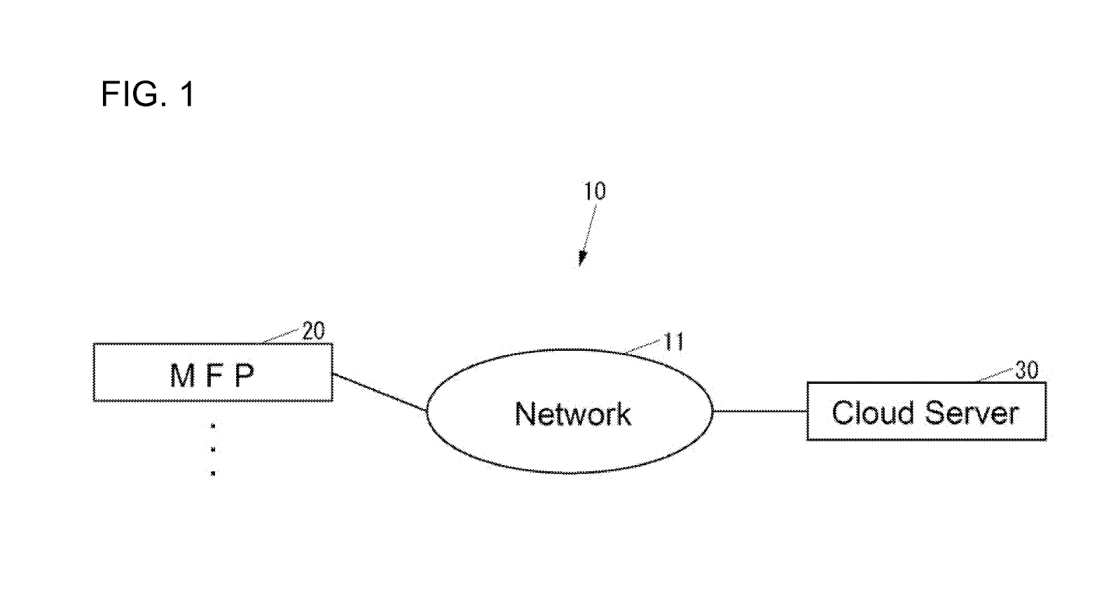

FIG. 1 illustrates a device management system 10 according to the embodiment.

As illustrated in FIG. 1, the device management system 10 includes a Multifunction Peripheral (MFP) 20 as an electronic device, a plurality of MFP that each have a similar configuration to the MFP 20, and a cloud server 30 as a device management apparatus that controls the MFP. The MFP and the cloud server 30 are connected in a communicable manner with each other via a network 11 such as a Local Area Network (LAN) and Internet.

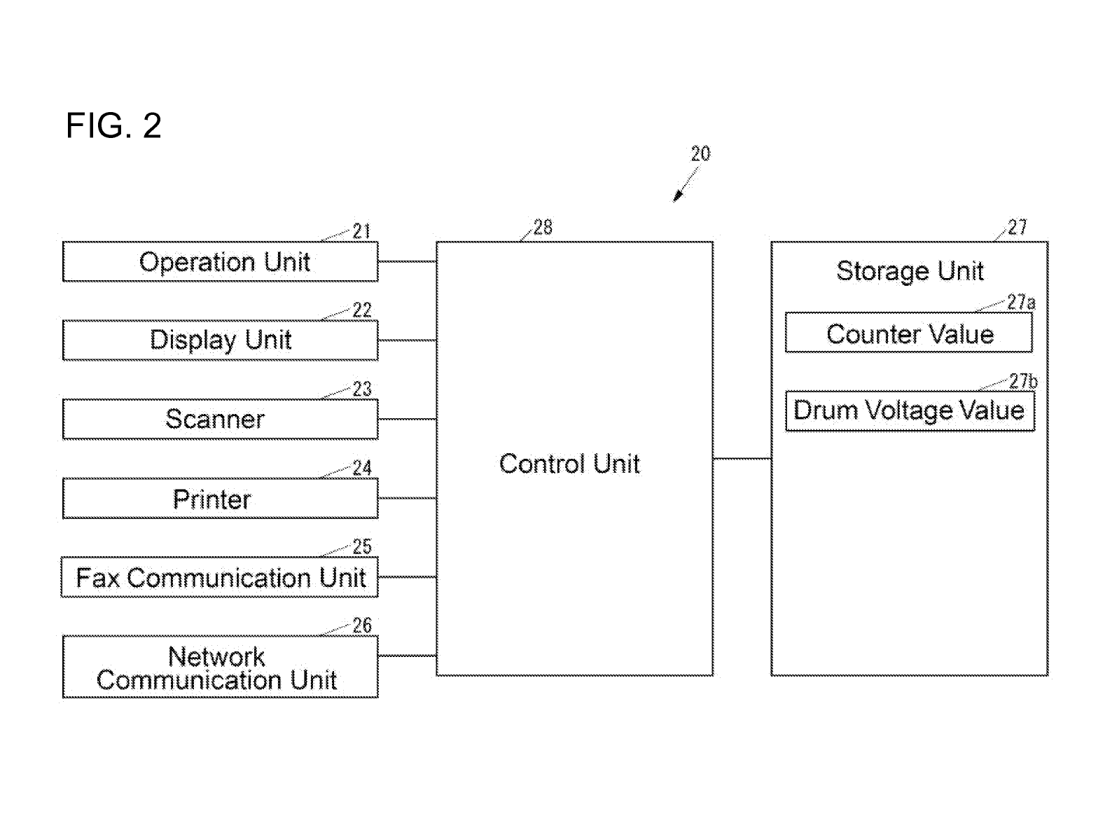

FIG. 2 illustrates the MFP 20.

As illustrated in FIG. 2, the MFP 20 includes an operation unit 21, a display unit 22, a scanner 23, a printer 24, a fax communication unit 25, a network communication unit 26, a storage unit 27, and a control unit 28. The operation unit 21 is an input device that includes such as a button and an input receiving circuit for inputting various kinds of operations. The display unit 22 is a display device that includes a circuit such as a Liquid Crystal Display (LCD) that displays various kinds of information. The scanner 23 is a reading device that includes a circuit that reads an image data from a document. The printer 24 is a print device that includes a circuit that executes print job on a recording medium such as paper sheet. The fax communication unit 25 is a fax device that includes a circuit that performs fax communication with an external facsimile device via a communication line such as a dial-up line. The network communication unit 26 is a network communication device that includes a circuit that communicates with an external device via the network 11 (see FIG. 1). The storage unit 27 is a storage device that includes a circuit such as an Electrically Erasable Programmable Read Only Memory (EEPROM) and a Hard Disk Drive (HDD), which stores various data. The control unit 28 is a processor that includes a circuit for controlling the entire MFP 20.

The storage unit 27 can store a counter value 27a indicating a count of the recording mediums printed by the printer 24 as a use amount value indicating the use amount of the MFP 20. The control unit 28 increases the counter value 27a every time at which the printer 24 performs the printing.

The storage unit 27 can store voltage values 27b (hereinafter referred to as “drum voltage value”), which is supplied to a photoreceptor drum of the printer 24, as an adjusting value necessary to be adjusted corresponding to the use amount of the MFP 20. When the printer 24 performs a printing, the control unit 28 supplies the voltage to the photoreceptor drum based on the drum voltage value 27b stored in the storage unit 27. When the constant voltage value is supplied to the photoreceptor drum irrespective of the use amount of the photoreceptor drum, the more the use amount of the photoreceptor drum by the printing, the harder the toner is attached to the photoreceptor drum because of the deterioration of the photoreceptor drum. As a result, the print density by the printer 24 becomes light. Accordingly, for stabilizing the print density by the printer 24, the drum voltage value 27b supplied to the photoreceptor drum should be larger as the use amount of the photoreceptor drum increasing. For example, when a serviceman determined the drum voltage value 27b is necessary to be adjusted with confirming a printing result of the printer 24 or similar way, the serviceman can adjust the drum voltage value 27b to increase via the operation unit 21 or similar way. When the electric potential on the photoreceptor drum surface becomes lower than the specific electric potential based on the detecting result of the electric potential on the photoreceptor drum surface by a sensor, the control unit 28 may adjust the drum voltage value 27b to increase automatically. The drum voltage value 27b can be adjusted between 200 V and 350 V.

The control unit 28 includes, for example, a Central Processing Unit (CPU), a Read Only Memory (ROM), which stores a program and various data, and a Random Access Memory (RAM), which is employed as a work area for the CPU. The CPU runs the program stored in the ROM or the storage unit 27, which is a non-transitory computer-readable recording medium.

The control unit 28 outputs the counter value 27a. Specifically, the control unit 28 continues to transmit the counter value 27a to the cloud server 30 via the network communication unit 26 every day.

The control unit 28 outputs the drum voltage value 27b. Specifically, when the drum voltage value 27b is changed, the control unit 28 transmits the combination of the changed drum voltage value 27b and the counter value 27a at the changed time point to the cloud server 30 via the network communication unit 26.

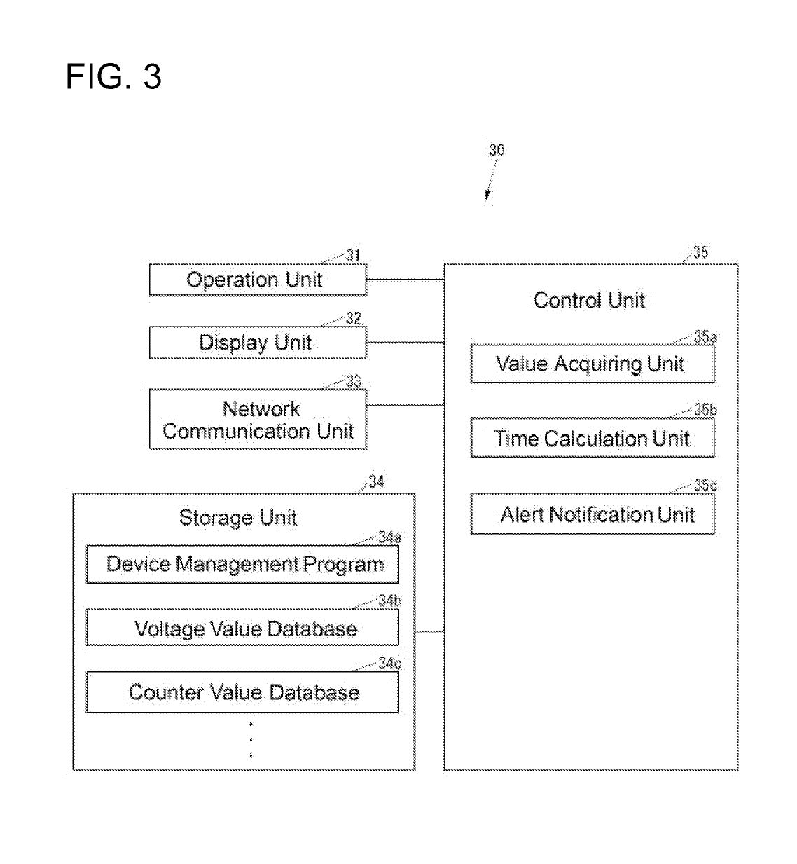

FIG. 3 illustrates the cloud server 30.

As illustrated in FIG. 3, the cloud server 30 includes an operation unit 31, a display unit 32, a network communication unit 33, a storage unit 34, and a control unit 35. The operation unit 31 is an input device that includes such as a computer mouse, a keyboard, and an input receiving circuit for inputting various kinds of operations. The display unit 32 is a display device that includes a circuit such as a LCD that displays various kinds of information. The network communication unit 33 is a network communication device that includes a circuit that communicates with an external device via the network 11 (see FIG. 1). The storage unit 34 is a storage device that includes a circuit such as a HDD that stores various data. The control unit 35 is a processor that includes a circuit that controls the entire the cloud server 30. The cloud server 30 is constituted of, for example, a computer such as a personal computer (PC).

The storage unit 34 stores a device management program 34a for controlling the MFP. The device management program 34a may be installed in the cloud server 30 at the production stage of the cloud server 30, may be installed additionally in the cloud server 30 from the storage medium such as a Compact Disk (CD), Digital Versatile Disk (DVD), and Universal Serial Bus (USB) memory, or may be installed additionally in the cloud server 30 from the network 11.

The storage unit 34 can store a voltage value database 34b, which is a log of the combinations of the counter values and the drum voltage values.

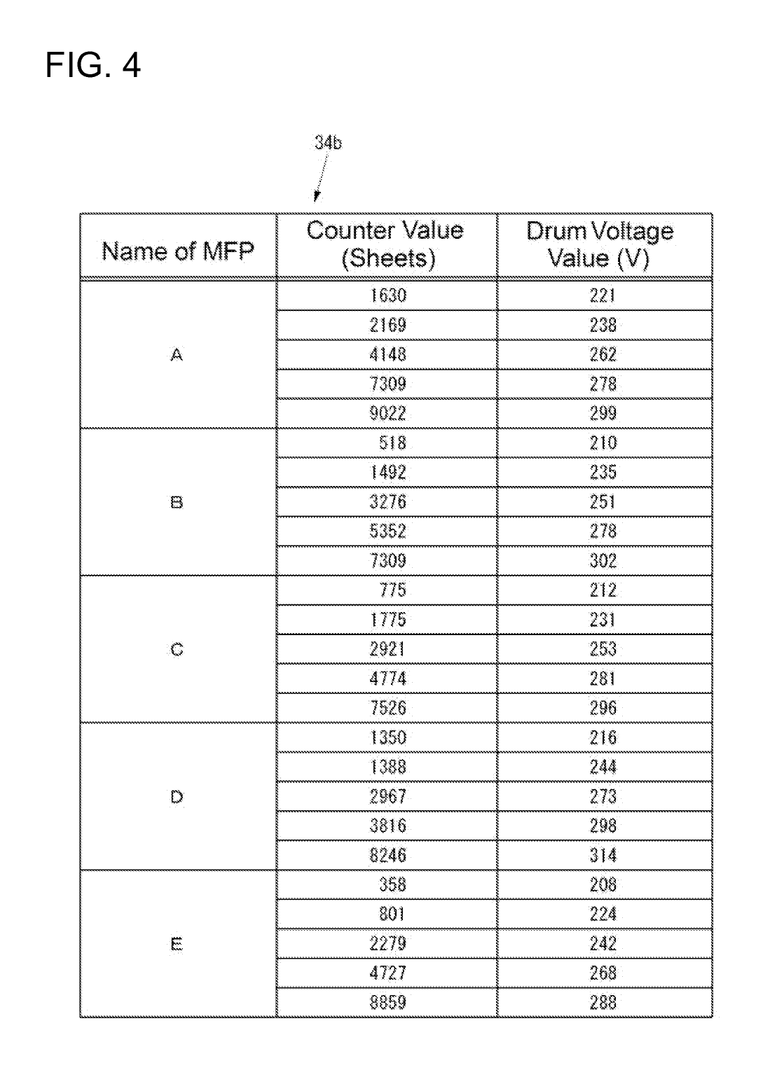

FIG. 4 illustrates an example of the voltage value database 34b.

As illustrated in FIG. 4, the voltage value database 34b is a log of the combinations of the counter values and the drum voltage values. For example, in the example illustrated in FIG. 4, an MFP “A” has the counter value of 1630 sheets at the point when the drum voltage value is 221 V.

As illustrated in FIG. 3, the storage unit 34 can store a counter value database 34c, which is a log of the counter values by each MFP.

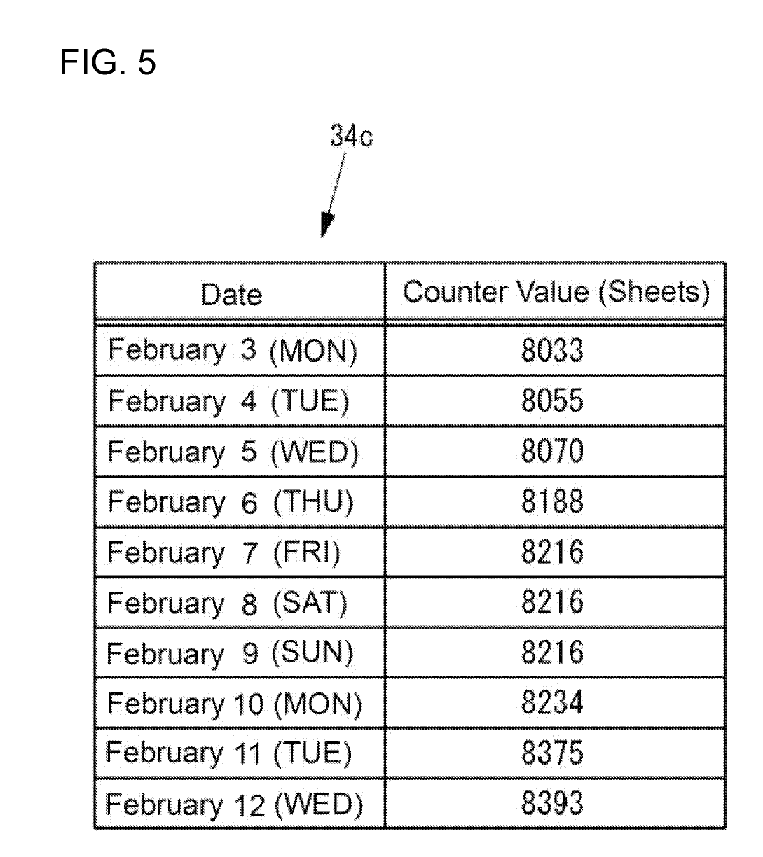

FIG. 5 illustrates an example of the counter value database 34c.

As illustrated in FIG. 5, the counter value database 34c is a log of the combinations of the counter values and the dates when the counter values are obtained. For example, in the example illustrated in FIG. 5, the counter value is 8033 sheets on February 3 (Monday).

The control unit 35 illustrated in FIG. 3 includes, for example, the CPU, the ROM that stores the program and various kinds of data, and the RAM that is employed as the work area of the CPU. The CPU runs the program stored in the ROM or the storage unit 34.

The control unit 35 runs the device management program 34a stored in the storage unit 34 to function as a value acquiring unit 35a, a time calculation unit 35b, and an alert notification unit 35c. The value acquiring unit 35a is a circuit that acquires the counter values and the drum voltage values from the MFP. The time calculation unit 35b is a circuit that calculates the adjustment-limit time at which the drum voltage value of the MFP reaches the limit. The alert notification unit 35c is a circuit that notifies the alert indicating that the adjustment-limit time calculated by the time calculation unit 35b is close.

Next, a description will be given of the performance of the cloud server 30.

First, a description will be given of the performance of the cloud server 30 when collecting information from the MFP.

The value acquiring unit 35a receives and acquires the combinations of the counter values and the drum voltage values via the network communication unit 33. The combinations of the counter values and the drum voltage values are transmitted from the MFP, which is connected to the cloud server 30 via the network 11. Then, the value acquiring unit 35a causes the voltage value database 34b to store the combinations of the counter values and the drum voltage values acquired from the MFP with combining with the name of the MFP.

The value acquiring unit 35a receives and acquires the counter value every day via the network communication unit 33. The counter value is transmitted from every MFP that is connected to the cloud server 30 via the network 11. Then, the value acquiring unit 35a causes the counter value database 34c of each of the MFPs to store the counter value acquired from the MFPs with combining with the date of the acquiring.

Next, a description will be given of the performance of the cloud server 30 when calculating the adjustment-limit time.

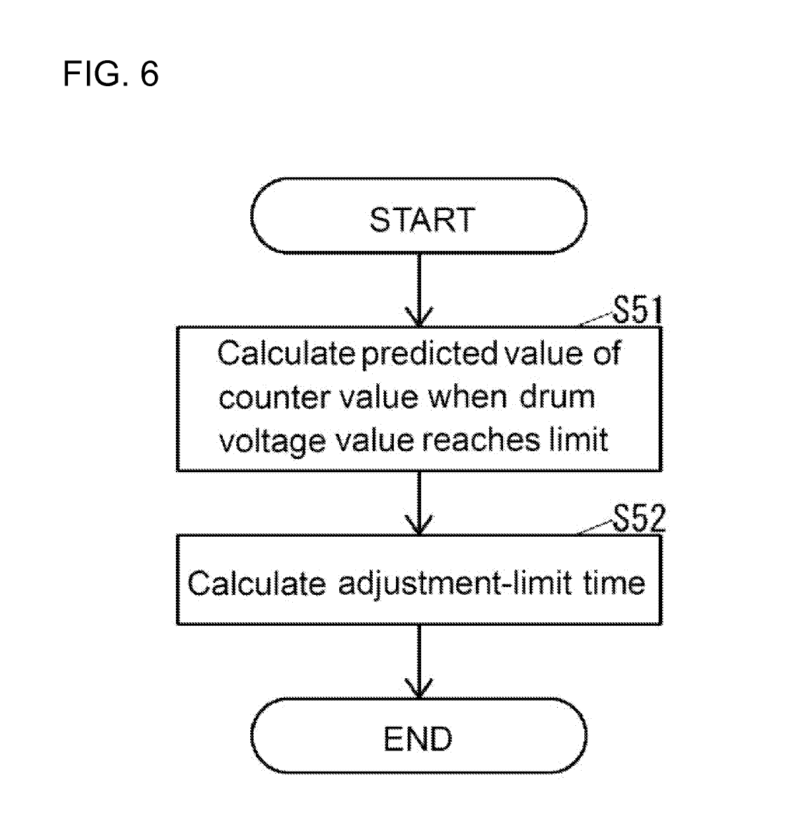

The time calculation unit 35b runs the performance illustrated in FIG. 6 every time at which the value acquiring unit 35a changes any of the voltage value database 34b and the counter value database 34c.

FIG. 6 illustrates the performance of the cloud server 30 when calculating the adjustment-limit time.

As illustrated in FIG. 6, the time calculation unit 35b calculates a predicted value of the counter value when the drum voltage value reaches the limit based on the log of the combinations of the counter values and the drum voltage values of the plurality of MFP in the voltage value database 34b (Step S51).

Here, a calculation method of the predicted value of the counter value when the drum voltage value reaches the limit will be described.

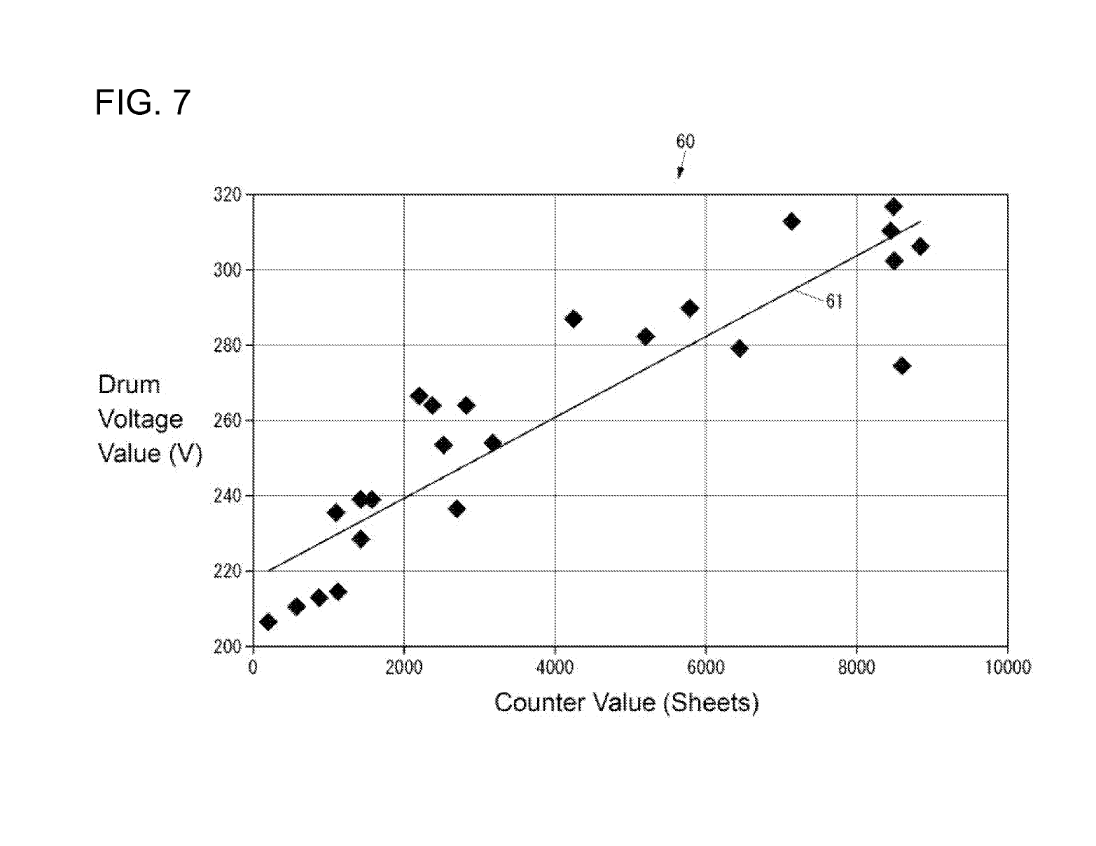

FIG. 7 illustrates an exemplary scatter diagram 60 of the combinations of the counter values and the drum voltage values of the plurality of MFP in the voltage value database 34b.

The scatter diagram 60 such as illustrated in FIG. 7 can be generated based on the log of the combinations of the counter values and the drum voltage values of the plurality of MFP in the voltage value database 34b.

Assuming that the counter value is x₁ and the drum voltage value is y₁, an approximate curve in the scatter diagram 60 illustrated in FIG. 7 is, for example, a linear approximate curve 61 indicated by the following formula.

y₁=0.0107x₁+218.63

Accordingly, assuming that the limit of the drum voltage value set in advance is 350 V for example, the time calculation unit 35b can calculate a value of 12277 (sheets) as the predicted value of the counter value x₁ when the drum voltage value y₁ reaches the limit of “350 V.” Namely, the product lifetime of the photoreceptor drum of the MFP can be predicted 12277 sheets for the counter value.

The predicted value of the counter value may be calculated lower to prevent the notification of the alert to the MFP where the photoreceptor drum reaches the product lifetime earlier than average from delaying. For example, in the scatter diagram 60 illustrated in FIG. 7, the time calculation unit 35b may obtain the linear approximate curve 61 ignoring data of the MFP where the photoreceptor drum reaches the product lifetime later than average equal to or more than the specific degree.

As illustrated in FIG. 6, the time calculation unit 35b calculates the time to reach the predicted value calculated in Step S51 as the adjustment-limit time based on the log of the counter values in the counter value database 34c of each MFP (Step S52).

Here, a calculation method of the adjustment-limit time will be described.

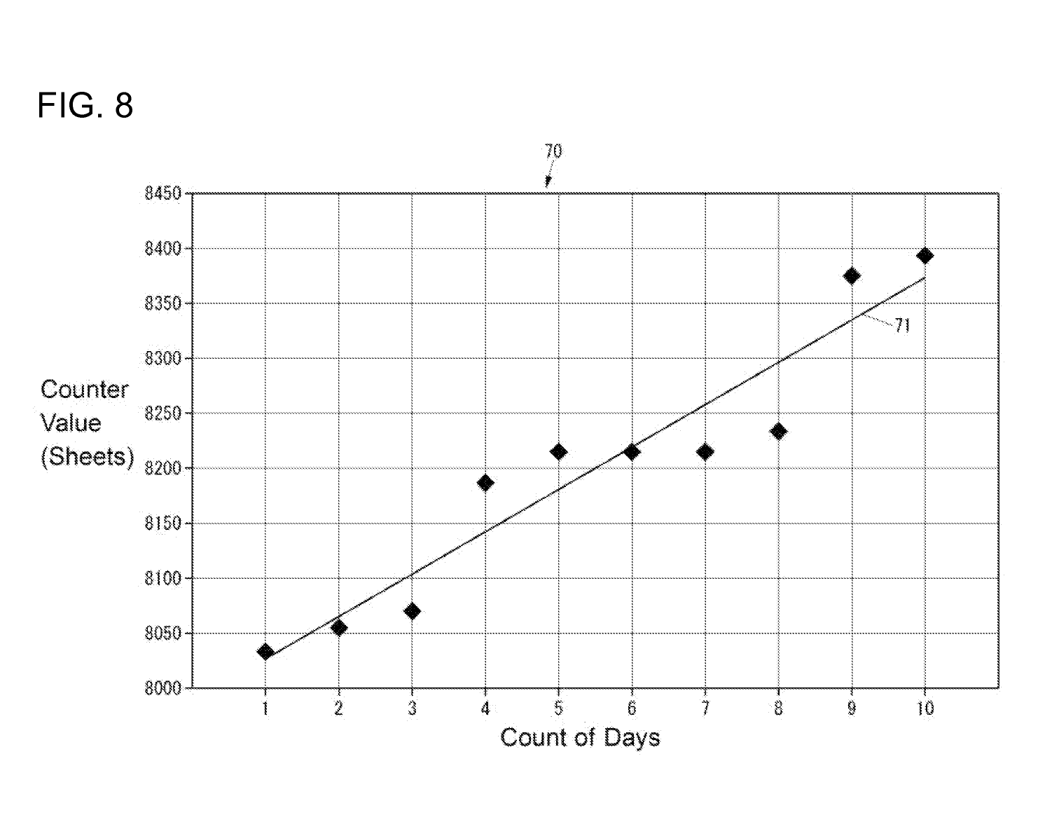

FIG. 8 illustrates an exemplary scatter diagram 70 of the counter values in the counter value database 34c.

The scatter diagram 70 such as illustrated in FIG. 8 can be generated based on the log of the counter values in the counter value database 34c.

Assuming that the count of days is x₂ and the counter value is y₂, an approximate curve in the scatter diagram 70 illustrated in FIG. 8 is, for example, a linear approximate curve 71 indicated by the following formula.

y₂=38.73x₂+7986.7

Accordingly, assuming that the predicted value of the counter value y₂ calculated in Step S51 is a value of 12277 (sheets), the time calculation unit 35b can calculate a value of 111 (days) as the count of days x₂ when the predicted value of the counter value y₂ reaches a value of 12277 (sheets). For example, assuming that the first day is February 3 (Monday), the adjustment-limit time of the photoreceptor drum of the MFP, namely, the time at which the drum voltage value cannot be adjusted can be predicted 110 days after from February 3 (Monday).

Next, a description will be given of the performance of the cloud server 30 when notifying the alert.

The alert notification unit 35c determines whether or not the adjustment-limit time, which is calculated by the processing illustrated in FIG. 6, reaches within the specific count of days from the current day every time at which the performance illustrated in FIG. 6 terminates. Then, when determining the adjustment-limit time, which is calculated by the processing illustrated in FIG. 6, reaches within the specific count of days from the current day, the alert notification unit 35c notifies the alert indicating that the adjustment-limit time is close, to an administrator of the target MFP. The alert may include a period from the current day to the adjustment-limit time.

As a method to notify, for example, the following method is available. That is, the alert notification unit 35c instructs the target MFP to transmit the alert indicating that the adjustment-limit time of the target MFP is close, to the administrator registered in the target MFP by a communication method such as e-mail via the network communication unit 33. As a method to notify, the following method is also accepted. That is, the alert notification unit 35c transmits the alert indicating that the adjustment-limit time of the target MFP is close, directly to a person registered as the administrator of the target MFP by a communication method such as e-mail via the network communication unit 33. Here, the administrator may be a serviceman of the target MFP.

When the administrator who has received the notification of the alert is not the serviceman, the photoreceptor drum can be exchanged by a serviceman when the target MFP is not used, with contacting the serviceman. When the administrator who has received the notification of the alert is the serviceman, the photoreceptor drum can be exchanged by the serviceman when the target MFP is not used. Accordingly, those methods can prevent the target MFP from being unusable suddenly with the photoreceptor drum reaching the limit during the target MFP is used.

As described above, the cloud server 30 notifies the alert indicating that the adjustment-limit time where the drum voltage value needing adjustment reaches the limit is close. The cloud server 30 notifies the alert corresponding not to the time at which the MFP use amount reaches the limit but corresponding to the MFP use amount. Accordingly, even when the MFP use amount reaches the limit set in advance, this can prevent from notifying the alert if the MFP is usable by adjusting the drum voltage value. Then, the cloud server 30 can improve the accuracy of the alert notification.

The cloud server 30 calculates the adjustment-limit time of each of the MFPs based on the log of the combinations of the counter values and the drum voltage values of the plurality of the MFP. Accordingly, the cloud server 30 can calculate the adjustment-limit time of the MFP with higher accuracy compared with the configuration that calculates the adjustment-limit time of each of the MFPs based on only the log of the combinations of the counter values and the drum voltage values of each of the MFPs. Accordingly, the cloud server 30 ensures the improved accuracy of the alert notification.

The cloud server 30 may employ the configuration that calculates the adjustment-limit time of the respective MFPs based on only the log of the combinations of the counter values and the drum voltage values of the respective MFPs.

The cloud server 30 may calculate the predicted value of the counter value when the drum voltage value reaches the limit based on the log of the combinations of the counter values and the drum voltage values of the plurality of MFP with an identical specific attribution. For example, when controlling a plurality of models of MFP, the cloud server 30 may calculate the predicted value of the counter value when the drum voltage value reaches the limit for each of the models. The cloud server 30 may calculate the predicted value of the counter value when the drum voltage value reaches the limit by each region where the MFP is installed with considering the influence to the product lifetime of the MFP by the climate and environment. The cloud server 30 may calculate the predicted value of the counter value when the drum voltage value reaches the limit by each temperature and humidity of the place where the MFP is installed by obtaining the temperature and humidity of the place where the MFP is installed from such as a built-in sensor of the MFP.

When calculating the adjustment-limit time for the respective MFPs based on the log of the combinations of the counter values and the drum voltage values of the plurality of MFPs, which have an identical specific attribution, the cloud server 30 can calculate the adjustment-limit time for the respective MFPs with high accuracy. Accordingly, the cloud server 30 ensures the improved accuracy of the alert notification.

In the above description, the linear approximate curve is indicated as the example of the approximate curve. However, the approximate curve may be the approximate curve other than the linear approximate curve.

While in the embodiment of the disclosure the adjusting value is the drum voltage value, the adjusting value may be a value other than the drum voltage value insofar as the value is necessary to be adjusted corresponding to the MFP use amount.

While in the embodiment of the disclosure the use amount value of the disclosure is the counter value, the use amount value may be the value other than the counter value insofar as the value indicates the MFP use amount. For example, the use amount value of the disclosure may be the count of days when the MFP is used.

While in the embodiment of the disclosure the electronic device of the disclosure is the MFP, the electronic device may be an image forming apparatus other than the MFP such as a printer-only machine, a copy-only machine, and a FAX-only machine, or may be an electronic device other than the image forming apparatus such as PC.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A device management system comprising:
an electronic device that outputs a use amount value and an adjusting value, the use amount value indicating a use amount of the electronic device and an adjusting value being to be adjusted corresponding to the use amount of the electronic device;
a device management apparatus that controls the electronic device;
a value acquiring circuit that acquires the use amount value and the adjusting value from the electronic device;
a time calculation circuit that calculates an adjustment-limit time at which the adjusting value of the electronic device reaches a limit of an adjustment of the electronic device; and
an alert notification circuit that notifies an alert indicating that the adjustment-limit time calculated by the time calculation circuit is close; wherein
the time calculation circuit calculates a predicted value of the use amount value where the adjusting value reaches the limit based on a log of combinations of the use amount values and the adjusting values, the use amount value and the adjusting value being acquired by the value acquiring circuit, and the time calculation circuit calculates the time at which the use amount value reaches the calculated predicted value based on a log of the use amount values as the adjustment-limit time.

2. The device management system according to claim 1, wherein:
the value acquiring circuit acquires the use amount values and the adjusting values from a plurality of the electronic devices;
the time calculation circuit calculates the predicted value based on the log of the combination of the use amount values and the adjusting values of the plurality of the electronic devices, and the time calculation circuit calculates the time at which the use amount value reaches the calculated predicted value based on the log of the use amount value of each of the electronic devices as the adjustment-limit time.

3. The device management system according to claim 2, wherein the time calculation circuit calculates the predicted value based on the log of the combinations of the use amount values and the adjusting values of the plurality of the electronic devices, the plurality of the electronic devices having an identical specific attribution.

4. A device management apparatus that controls an electronic device outputting a use amount value and an adjusting value, the use amount value indicating a use amount of the electronic device and the adjusting value being to be adjusted corresponding to the use amount of the electronic device, the device management apparatus comprising:
a value acquiring circuit that acquires the use amount value and the adjusting value from the electronic device;
a time calculation circuit that calculates an adjustment-limit time at which the adjusting value of the electronic device reaches a limit of an adjustment of the electronic device; and
an alert notification circuit that notifies an alert indicating that the adjustment-limit time calculated by the time calculation circuit is close; wherein
the time calculation circuit calculates a predicted value of the use amount value where the adjusting value reaches the limit based on a log of combinations of the use amount values and the adjusting values, the use amount value and the adjusting value being acquired by the value acquiring circuit, and the time calculation circuit calculates the time at which the use amount value reaches the calculated predicted value based on a log of the use amount values as the adjustment-limit time.

5. A device management method for controlling an electronic device outputting a use amount value and an adjusting value, the use amount value indicating a use amount of the electronic device and the adjusting value being to be adjusted corresponding to the use amount of the electronic device, the device management method comprising:
acquiring the use amount value and the adjusting value from the electronic device via a value acquiring circuit;
calculating adjustment-limit time at which the adjusting value of the electronic device reaches a limit of an adjustment of the electronic device via a time calculation circuit; and
notifying an alert indicating that the adjustment-limit time calculated by the calculating is close via an alert notification circuit; wherein
the calculating calculates a predicted value of the use amount value in case of the adjusting value reaching the limit based on a log of the combination of the use amount values and the adjusting values, the use amount value and the adjusting value being acquired by the acquiring, and the calculating calculates the time at which the use amount value reaches the calculated predicted value based on a log of the use amount values as the adjustment-limit time.
